(19) United States
(12) Patent Application Publication
(10) Pub. No.: US 2014/0055733 A1
(43) Pub. Date: Feb. 27, 2014

(54) LIQUID CRYSTAL PANEL AND LIQUID CRYSTAL DISPLAY

(71) Applicants: Yubo Gu, Shenzhen (CN); Liuyang Yang, Shenzhen (CN); Pei Jia, Shenzhen (CN)

(72) Inventors: Yubo Gu, Shenzhen (CN); Liuyang Yang, Shenzhen (CN); Pei Jia, Shenzhen (CN)

(73) Assignee: Shenzhen China Star Optoelectronics Technology Co Ltd., Shenzhen, Guangdong (CN)

(21) Appl. No.: 13/702,584

(22) PCT Filed: Aug. 29, 2012
(86) PCT No.: PCT/CN2012/080729

§ 371 Date: Dec. 7, 2012

(30) Foreign Application Priority Data
Aug. 21, 2012 (CN) 201210298888.2

(51) Int. Cl. G02F 1/1343

(52) U.S. Cl. CPC G02F 1/134336
USPC 349/141; 349/147

(57) ABSTRACT

A liquid crystal panel and liquid crystal display, this liquid crystal panel comprising: a lower substrate with a pixel matrix, an upper substrate with a color filter, and a liquid crystal layer arranged between the upper and lower substrates; the pixel region is provided with a pixel electrode and a first common electrode, and the liquid crystal panel further includes a second common electrode layer arranged on the lower surface of the upper substrate, with the voltage applied to the second common electrode layer for working being the same with that applied to the first common electrode. With the technical solution of the present invention, a voltage difference is generated respectively between these two common electrodes and the pixel electrode after the voltage is applied, thus making the liquid crystal between the lower and upper substrates achieve a better alignment effect, reducing the display defects and improving the display effect.

### FIELD OF THE INVENTION

The present invention relates to the liquid crystal displaying field, and particularly to a liquid crystal panel and liquid crystal display.

### BACKGROUND OF THE INVENTION

A liquid crystal display (LCD) has been widely used because it keeps high-quality display even under the low power condition. For the liquid crystal display, each pixel can be simplified in structure to be a layer of liquid crystal sandwiched between the pixel electrode and the common electrode. After the pixel electrode is sufficiently charged, the liquid crystal molecules between the electrodes, driven by the electric field, will have arrangement changes and zigzag changes, thus producing a picture and forming a picture through perspective reflection of the external light.

FIG. 1 is a sectional view of the liquid crystal panel of the prior art in the FFS (Fringe Field Switching) mode, which includes a lower substrate 100, an upper substrate 108 and a liquid crystal layer 106 arranged therebetween. And a plurality of control lines and a plurality of data lines on the lower substrate 100 cross each other to form a pixel matrix, with the pixel region provided with a common electrode 102 and a pixel electrode 105. However, because the pixel electrode 105 and the common electrode 102 are both designed to be on the lower substrate 100 in the design of the liquid crystal panel, the liquid crystal away from the lower substrate 100 but close to the upper substrate 108 is not easy to be driven, thus affecting alignment of the liquid crystal and the display effect. This situation also exists in the liquid crystal panel in the IPS (In-Plane Switching) mode.

### SUMMARY OF THE INVENTION

Aiming at the above defect in the prior art of poor alignment effect of the liquid crystal away from the lower substrate, the technical problem to be solved by the present invention is to provide a liquid crystal panel and liquid crystal display to enable all the liquid crystal between the lower and upper substrates to achieve a better alignment effect.

The present invention adopts the following technical solutions to solve its technical problem: A liquid crystal panel is provided, comprising: a lower substrate with a pixel matrix, an upper substrate with a color filter, and a liquid crystal layer arranged between the upper and lower substrates; the pixel region is provided with a pixel electrode and a first common electrode, and the liquid crystal panel further includes a second common electrode layer arranged on the lower surface of the upper substrate, with the voltage applied to the second common electrode layer for working being the same with that applied to the first common electrode.

In the liquid crystal panel of the present invention, the pixel electrode and the first common electrode cross each other in the same plane.

In the liquid crystal panel of the present invention, an insulating layer is arranged between the first common electrode and the pixel electrode, with the pixel electrode above the first common electrode.

In the liquid crystal panel of the present invention, the first common electrode, the second common electrode layer and the pixel electrode are a transparent electrode, respectively.

In the liquid crystal panel of the present invention, the pixel electrode is in a comb shape.

In the liquid crystal panel of the present invention, the first common electrode is in a comb or flat panel shape.

The present invention further provides a liquid crystal display comprising a liquid crystal panel, this liquid crystal panel including: a lower substrate with a pixel matrix, an upper substrate with a color filter, and a liquid crystal layer arranged between the upper and lower substrates; the pixel region is provided with a pixel electrode and a first common electrode, and the liquid crystal panel further includes a second common electrode layer arranged on the lower surface of the upper substrate, with the voltage applied to the second common electrode layer for working being the same with that applied to the first common electrode.

In the liquid crystal display of the present invention, the liquid crystal panel is an IPS-mode display panel, and the pixel electrode and the first common electrode cross each other in the same plane.

In the liquid crystal display of the present invention, the liquid crystal panel is an FFS-mode display panel, and an insulating layer is arranged between the first common electrode and the pixel electrode, with the pixel electrode above the first common electrode.

In the liquid crystal display of the present invention, the pixel electrode is in a comb shape, and the first common electrode is in a comb or flat panel shape.

With the technical solution of the present invention, a voltage difference is generated respectively between the first common electrode and the pixel electrode and between the second common electrode layer and the pixel electrode after the voltage is applied, thus making the liquid crystal between the lower and upper substrates achieve a better alignment effect, reducing the display defects and improving the display effect.

### BRIEF DESCRIPTION OF THE DRAWINGS

The present invention will further be explained with reference to drawings and examples. In the drawings:

FIG. 1 is a sectional view of the liquid crystal panel of the prior art in the FFS mode; and

FIG. 2 is a sectional view of Example 1 of the liquid crystal panel of the present invention in the FFS mode.

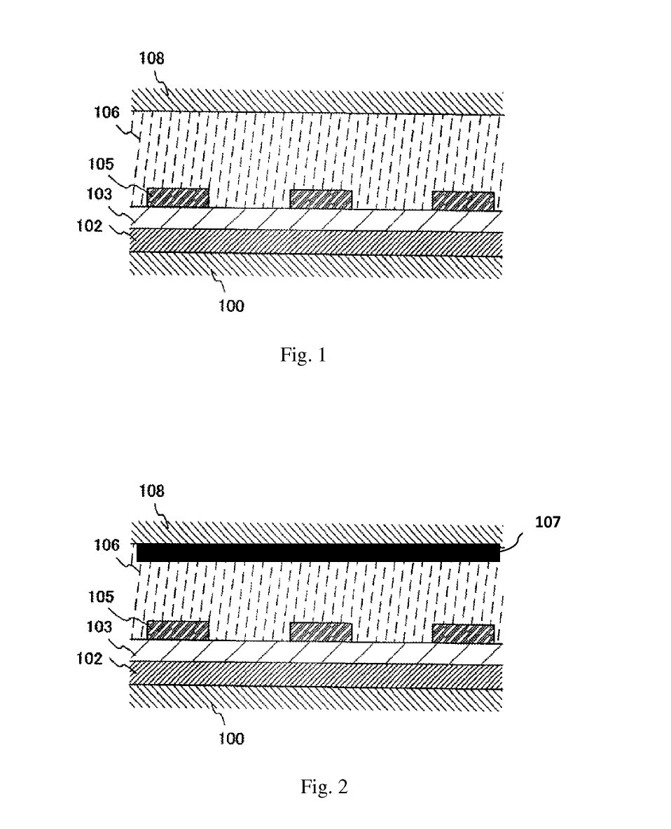

### DETAILED DESCRIPTION OF THE PREFERRED EMBODIMENT

In Example 1 of the liquid crystal panel of the present invention, this liquid crystal panel includes a lower substrate and an upper substrates opposite to each other, with a liquid crystal layer arranged therebetween; the upper substrate is provided with a pixel matrix, and the pixel region is provided with a pixel electrode and a first common electrode. The upper substrate is provided with a color filter, and a second common electrode layer is formed on the lower surface of the upper substrate, with the same voltage applied to the first common electrode and the second common electrode layer while working. A voltage difference is generated respectively between these two common electrodes and the pixel electrode after the voltage is applied, thus making the liquid crystal between the lower substrate and the upper substrate achieve a better alignment effect, reducing the display defects and improving the display effect.

In another example of the liquid crystal panel of the present invention, the liquid crystal panel is in the IPS mode, and thus the pixel electrode and the first common electrode at the side of its lower substrate cross each other in the same plane, with other structures identical with those in the above example and not to be described again. After the voltage is applied, the liquid crystal molecules make a torsion movement in parallel with the upper and lower substrates.

In yet another example of the liquid crystal panel of the present invention, the liquid crystal panel is in the FFS mode. As shown in FIG. 2, this liquid crystal panel in the FFS mode includes a lower substrate 100 with the pixel matrix, an upper substrate 108 with the color filter, and a liquid crystal layer 106 arranged between the upper substrate 108 and the lower substrate 100; the pixel region is provided with a first common electrode 102 and a pixel electrode 105, and the pixel electrode 105 is above the first common electrode 102, with an insulating layer 103 further arranged therebetween. A second common electrode layer 107 is formed on the lower surface of the upper substrate 108, with the same voltage applied to the first common electrode 102 and the second common electrode layer 107 while working. After the voltage is applied, all the liquid crystal molecules between the first common electrode 102 and the pixel electrode 105 as well as just above the pixel electrode 105 can make rotary conversion in the plane direction (in parallel with the upper and lower substrates), thus improving the light transmission efficiency of the liquid crystal layer.

Besides, in the liquid crystal panel in the FFS mode, the first common electrode 102, the second common electrode layer 107, and the pixel electrode 105 are a transparent electrode, respectively. Moreover, the pixel electrode 105 can be in a comb shape, and the first common electrode 102 is in a comb or flat panel shape.

In addition, the present invention further provides a liquid crystal display that includes the liquid crystal panel in any of the above examples. When a light beam is incident on the liquid crystal panel, an image signal is inputted into a driving chip, which controls light transmission of the liquid crystal to make strength and distribution of the light through the liquid crystal panel subject to the corresponding modulation, thereby forming a picture.

All the above are only the preferred examples of the present invention, and do not limit the present invention. For those skilled in the art, the present invention can have a variety of alteration and change. Any amendment, equivalent replacement, improvement, etc. within the spirit and principle of the present invention shall fall within the scope of claims of the present invention.

What is claimed is:

1. A liquid crystal panel, comprising: a lower substrate with a pixel matrix, an upper substrate with a color filter, and a liquid crystal layer arranged between the upper substrate and the lower substrate; characterized in that the pixel region is provided with a pixel electrode and a first common electrode, and the liquid crystal panel further includes a second common electrode layer arranged on a lower surface of the upper substrate, with a voltage applied to the second common electrode layer for working being the same with that applied to the first common electrode.

2. The liquid crystal panel according to claim 1, characterized in that the pixel electrode and the first common electrode cross each other in a same plane.

3. The liquid crystal panel according to claim 1, characterized in that an insulating layer is arranged between the first common electrode and the pixel electrode, with the pixel electrode above the first common electrode.

4. The liquid crystal panel according to claim 3, characterized in that the first common electrode, the second common electrode layer and the pixel electrode are a transparent electrode, respectively.

5. The liquid crystal panel according to claim 3, characterized in that the pixel electrode is in a comb shape.

6. The liquid crystal panel according to claim 3, characterized in that the first common electrode is in a comb or flat panel shape.

7. A liquid crystal display, comprising a liquid crystal panel, this liquid crystal panel including: a lower substrate with a pixel matrix, an upper substrate with a color filter, and a liquid crystal layer arranged between the upper substrate and the lower substrate; characterized in that the pixel region is provided with a pixel electrode and a first common electrode, and the liquid crystal panel further includes a second common electrode layer arranged on the lower surface of the upper substrate, with the voltage applied to the second common electrode layer for working being the same with that applied to the first common electrode.

8. The liquid crystal display according to claim 7, characterized in that the liquid crystal panel is an IPS-mode display panel, and the pixel electrode and the first common electrode cross each other in the same plane.

9. The liquid crystal display according to claim 7, characterized in that the liquid crystal panel is an FFS-mode display panel, and an insulating layer is arranged between the first common electrode and the pixel electrode, with the pixel electrode above the first common electrode.

10. The liquid crystal display according to claim 9, characterized in that the pixel electrode is in a comb shape, and the first common electrode is in a comb or flat panel shape.
